(19) United States
(12) Patent Application Publication
(10) Pub. No.: US 2021/0171133 A1
(43) Pub. Date: Jun. 10, 2021

(54) MONITORING SYSTEM, TRAVELING MACHINE SYSTEM AND MONITORING METHOD

(71) Applicant: BRIDGESTONE CORPORATION, Tokyo (JP)

(72) Inventor: Satoshi KONDO, Tokyo (JP)

(73) Assignee: BRIDGESTONE CORPORATION, Tokyo (JP)

(21) Appl. No.: 17/109,141

(22) Filed: Dec. 2, 2020

(30) Foreign Application Priority Data
Dec. 5, 2019 (JP) 2019-220319

(51) Int. Cl. B62D 55/24; B62D 55/30; B62D 55/092; E02F 9/26

(52) U.S. Cl. CPC B62D 55/24; E02F 9/26; B62D 55/092; B62D 55/30

(57) ABSTRACT

A monitoring system 4 of the present disclosure is a monitoring system which is used for a traveling machine 3 having a rubber crawler 1 and a machine body 2, and includes an angle sensor 45, a force sensor 41 and a processing section 42. The rubber crawler includes a plurality of cores 13 which are arranged along a crawler circumferential direction and is mounted to an underbody 21 of the machine body, the angle sensor is configured to detect an inclination angle to a horizontal surface of the machine body, the force sensor is configured to detect a force applied from the rubber crawler to an idler of the underbody or a physical amount correlating with the force, and the processing section is configured to determine existence or non-existence of a prior warning of deviation based on outputs from the angle sensor and the force sensor.

### TECHNICAL FIELD

The present disclosure relates to a monitoring system, a traveling machine system and a monitoring method.

This application is based upon and claiming the benefit of priority from Japanese Patent Application No. 2019-220319, filed in Japan on Dec. 5, 2019, the entire content of which is incorporated herein by reference.

### BACKGROUND

Conventionally, there has been a traveling machine in which a rubber crawler containing a core is mounted to a machine body (for example, JP2011207317A (PTL 1).

### CITATION LIST

### Patent Literature

PTL 1: JP2011207317A

### SUMMARY

In the traveling machine as described above, generally, at the time of traveling on an inclined surface, deviation (a rubber crawler is removed from an underbody of a machine body) may occur. However, conventionally, an operator who drives a traveling machine has to predict a prior warning of deviation sensuously from an attitude of the machine body, a traveling state or a sound etc., and grasping the prior warning of deviation has been difficult.

An object of the present disclosure is to provide a monitoring system, a traveling machine system and a monitoring method which ensures grasping of a prior warning of deviation more reliably.

According to the present disclosure, there is provided a monitoring system which is used for a traveling machine having a rubber crawler and a machine body, the monitoring system including: an angle sensor; a force sensor; and a processing section, wherein the rubber crawler includes a plurality of cores which are arranged along a crawler circumferential direction and is mounted to an underbody of the machine body, the angle sensor is configured to detect an inclination angle to a horizontal surface of the machine body, the force sensor is configured to detect a force applied from the rubber crawler to an idler of the underbody or a physical amount correlating with the force, and the processing section is configured to determine existence or non-existence of a prior warning of deviation based on outputs from the angle sensor and the force sensor.

In the traveling machine system according to the present disclosure, the above-described monitoring system and the traveling machine including the rubber crawler and the machine body are included.

In the monitoring method according to the present disclosure, there is provided a monitoring method which uses the above-described monitoring system, including: an angle detecting step in which the angle sensor detects an inclination angle to a horizontal surface of the machine body; a force detecting step in which the force sensor detects the force applied from the rubber crawler to the idler of the underbody or the physical amount correlating with the force; and a determining step in which the processing section determines existence or non-existence of the prior warning of deviation based on the output from the angle sensor in the angle detecting step and the output from the force sensor in the force detecting step.

According to the present disclosure, the monitoring system, the traveling machine system and the monitoring method which ensure grasping of the prior warning of deviation more reliably can be provided.

### BRIEF DESCRIPTION OF THE DRAWINGS

In the accompanying drawings:

FIG. 1 is a schematic drawing illustrating a monitoring system according to one embodiment of the present disclosure and a traveling machine system according to one embodiment of the present disclosure;

FIG. 2 is a side view illustrating an underbody apparatus of FIG. 1 with a force sensor of FIG. 1;

FIG. 3 is a perspective view illustrating a part of a rubber crawler of FIG. 1 with a cross section in a width direction;

FIG. 4 is an explanation view for explaining a tension mechanism and the force sensor of FIG. 2;

FIG. 5 is an explanation view illustrating an appearance of the traveling machine of FIG. 1 seen from the rear side for explaining a state that there is a prior warning of deviation in the traveling machine of FIG. 1; and

FIG. 6 is an explanation view illustrating an apparatus of a left underbody apparatus of FIG. 5 seen from an inner side in a machine body right-left direction for explaining a state that there is a prior warning of deviation in the traveling machine of FIG. 1.

### DETAILED DESCRIPTION

A monitoring system, a traveling machine system and a monitoring method according to the present disclosure is preferably applied to a traveling machine including a rubber crawler containing a core, and, for example, preferably applied to a construction machinery (including a mini-excavator) and agricultural machines (including a tractor and a combine).

Hereinafter, an embodiment of the monitoring system, the traveling machine system and the monitoring method according to the present disclosure will be explained with illustration with reference to the drawings.

In each drawing, common constituent elements are applied the same reference numerals.

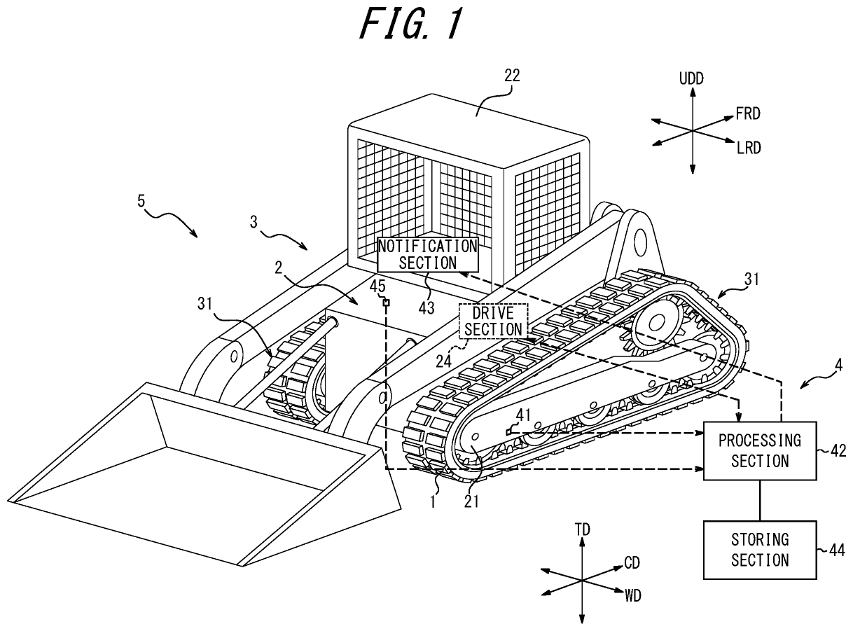

FIGS. 1 to 6 are drawings for explaining a monitoring system 4 according to one embodiment of the present disclosure, a traveling machine system 5 according to one embodiment of the present disclosure and a monitoring system according to one embodiment of the present disclosure.

[Traveling Machine System 5]

First, a configuration of the traveling machine system 5 of this embodiment will be explained.

As illustrated in FIG. 1, the traveling machine system 5 of this embodiment includes a traveling machine 3 and the monitoring system 4 of this embodiment. The traveling machine 3 has a rubber crawler 1 and a machine body 2. The monitoring system 4 is configured to be used for the traveling machine 3, and more specifically, configured to monitor as to whether there is a prior warning of deviation in the traveling machine 3.

(Traveling Machine 3)

Hereinafter, the traveling machine 3 will be explained. As described above, the traveling machine 3 has the rubber crawler 1 and the machine body 2. The rubber crawler 1 is mounted to an underbody 21 of the machine body 2. While the traveling machine 3 may be configured as a construction machinery (including a mini-excavator) and agricultural machines (including a tractor and a combine) for example, use may be arbitrary as long as it is configured to travel using a rubber crawler containing a core, and also, the configuration may be arbitrary not limited to one explained with illustration in the present specification.

The traveling machine 3 has an underbody apparatus 31 configured to drive on a road surface. The underbody apparatus 31 of the traveling machine 3 has the underbody 21 of the machine body 2 and the rubber crawler 1 mounted to the underbody 21. The traveling machine 3 may include one or more underbody apparatuses 31. In an example of FIG. 1, the traveling machine 3 includes two underbody apparatuses 31 (one on each of right and left sides), and thus, two units of the underbody 21 of the machine body 2 and the rubber crawler 1 (one on each of right and left sides).

<Rubber Crawler 1>

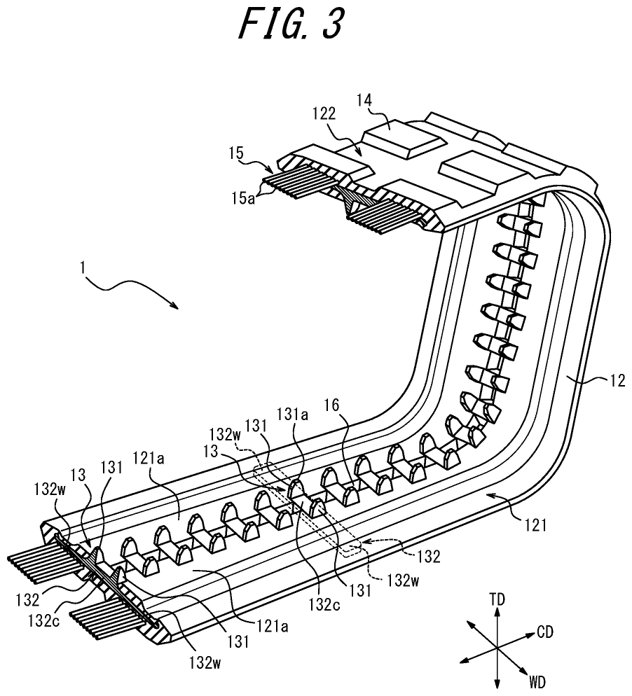

Here, the rubber crawler 1 will be explained. FIG. 3 illustrates the rubber crawler 1 alone. The rubber crawler 1 is configured as a rubber crawler containing a core. As illustrated in FIG. 3, the rubber crawler 1 includes a crawler body 12, a plurality of lugs 14, one or more cord layers 15, a plurality of cores 13 and a plurality of holes 16.

The crawler body 12 is configured as endless (annular). The crawler body 12 is configured as a belt. The crawler body 12 is constituted by rubber.

Additionally, in the present specification, “a crawler inner circumferential side,” “a crawler outer circumferential side,” “a crawler circumferential direction (CD),” “a crawler width direction (WD)” and “a crawler thickness direction (TD)” respectively refer to an inner circumferential side, an outer circumferential side, a circumferential direction, a width direction and a thickness direction in the crawler body 12, and these are directions fixed to the crawler body 12. In each drawing, for convenience, the crawler circumferential direction (CD) is illustrated by an arrow CD, the crawler width direction (WD) is illustrated by an arrow WD and the crawler thickness direction (TD) is illustrated by an arrow TD.

Each of the plurality of lugs 14 included by the rubber crawler 1 protrudes from an outer circumferential surface 122 of the crawler body 12 to the crawler outer circumferential side. The shape or arrangement of the lugs 14 are not limited to one illustrated in each drawing, and may be arbitrary. End surfaces at the crawler outer circumferential side of the lug 14 are configured to contact the road surface. The lugs 14 are constituted by rubber.

The cord layer 15 includes a plurality of cords 15a arranged along the crawler width direction WD. Each of these cords 15a extends over the entire circumference along the crawler circumferential direction CD. The cord layer 15 is embedded in an inner portion of the crawler body 12. As in an example illustrated in FIG. 3, the rubber crawler 1 may include the cord layer 15 only at one portion in the crawler thickness direction TD (in this case, the number of layers of the cord layer 15 is one layer), or may include the cord layer 15 at plural portions in the crawler thickness direction TD (in this case, the number of layers of the cord layer 15 is plural layers).

The cord layer 15 has a function of inhibiting the crawler body 12 from extending in the crawler circumferential direction CD.

For example, the cord 15a is constituted by metal (such as steel).

The plurality of cores 13 included by the rubber crawler 1 are arranged along the crawler circumferential direction CD. These cores 13 are arranged with constant pitch intervals along the crawler circumferential direction CD. Here, “pitch interval” refers to a distance in the crawler circumferential direction CD between centers of a pair of cores 13 in the crawler circumferential direction CD, the pair of cores 13 being adjacent to each other in the crawler circumferential direction CD.

Each core 13 is constituted by metal (for example, iron or steel).

Each core 13 is partially embedded in the inner portion of the crawler body 12. Each core 13 is arranged at the crawler inner circumferential side than the cord layer 15.

Each core 13 includes a base portion 132 and a pair of projections 131. The base portion 132 is configured as plate-like for example, and extends in the crawler width direction WD. In the example in FIG. 3, the base portion 132 is substantially rectangular as illustrated by a dashed line in FIG. 3 in which the crawler width direction is a longitudinal direction in a planar view of the base portion 132. Additionally, the shape of the base portion 132 in the planar view may be another shape. Each of the pair of projections 131 extends from the base portion 132 toward the crawler inner circumferential side. Each projection 131 partially or entirely projects toward the crawler inner circumferential side than an inner circumferential surface 121 of the crawler body 12. The pair of projections 131 are separated from each other in the crawler width direction WD. The pair of projections 131 are respectively positioned at both sides about the center of the base portion 132 in the crawler width direction WD. Of the base portion 132, a central portion 132c connects the pair of projections 131. Of the base portion 132, a pair of wing portions 132w are constituted by outer portions than the pair of projections 131 in the crawler width direction WD. The base portion 132 is embedded in the inner portion of the crawler body 12.

Of the projections 131 of the core 13, a portion projecting to the crawler inner circumferential side than the inner circumferential surface 121 of the crawler body 12 may be partially or entirely covered by a membranous rubber (a coating rubber which is not illustrated), or may be exposed to the outside, not covered by the membranous rubber (the coating rubber which is not illustrated).

Also, the base portion 132 of the core 13 may be entirely covered by the crawler body 12, or a portion thereof (for example, the central portion 132c) may be exposed to the outside, not covered by the crawler body 12.

The central portion 132c of the base portion 132 of the core 13 has a function of transmitting a driving force from a sprocket 212 to the rubber crawler 1 by engaging with a pin 212p of the sprocket 212 of the underbody 21 of the machine body 2 not through rubber or through rubber. The pair of projections 131 of the core 13 have a function as a guide which, not through rubber or through rubber, controls movement of each rotating body (the sprocket 212, an idler 213, a track roller 214) of the underbody 21 of the machine body 2 in the crawler width direction WD, thereby inhibiting deviation.

Additionally, in the present specification, “a top surface (131a)” of the projection (131) of the core 13 refers to an end surface at the crawler inner circumferential side of the projection (131). “A root” of the projection (131) of the core 13 refers to a virtual end surface at the crawler outer circumferential side of the projection (131), corresponding to a cross section of the projection (131) at a position where the projection (131) and the base portion (132) are connected. “A side surface” of the projection (131) of the core 13 refers to, of surfaces of the projection (131), ones other than the top surface (131a) and the root.

Of the inner circumferential surface 121 of the crawler body 12, portions which are adjacent to the pair of projections 131 of the core 13 at both outer sides in the crawler width direction WD constitute track roller passing surfaces 121a. Each track roller passing surface 121a is configured such that the track roller 214 rolls thereon.

As in the example in FIG. 3, each track roller passing surface 121a is preferably configured as flat without unevenness over the entire circumference at least partially in the crawler width direction WD.

Each of the plurality of holes 16 included by the rubber crawler 1 is formed between the central portions 132c of the projections 131 in the crawler circumferential direction CD. Each hole 16 is concave toward the crawler outer circumferential side. Each hole 16 is configured such that the pin 212p of the sprocket 212 can be inserted.

Each hole 16 may be configured as a bottomed hole (a concave) not passing through the crawler body 12 in the crawler thickness direction TD, or may be configured as a bottomless hole (a through-hole) passing through the crawler body 12 in the crawler thickness direction TD.

Each hole 16 is concave to the crawler outer circumferential side than an end surface at the crawler inner circumferential side of the central portion 132c of the projection 131. Due to this, the pin 212p of the sprocket 212 can engage with the central portion 132c of the core 13 in a state that it is inserted in the hole 16, and thus transmit the driving force to the rubber crawler 1.

In the example of FIG. 3, the hole 16 is formed on the crawler body 12 and is concave to the crawler outer circumferential side than the inner circumferential surface 121 of the crawler body 12. Additionally, the hole 16 is not necessarily concave to the crawler outer circumferential side than the inner circumferential surface 121 of the crawler body 12 as long as the hole 16 is concave to the crawler outer circumferential side than the end surface at the crawler inner circumferential side of the central portion 132c of the projection 131, and may be arranged only at the crawler inner circumferential side than the inner circumferential surface 121 of the crawler body 12.

<Machine Body 2>

Next, the machine body 2 will be explained. The machine body 2 is a portion other than the rubber crawler 1 of the traveling machine 3.

Additionally, in the present specification, “a machine body up-down direction (UDD),” “a machine body front-rear direction (FRD)” and “the machine body right-left direction (LRD)” respectively refer to the up-down direction, the front-rear direction and the right-left direction seen from an operator who rides the machine body 2, and these are directions fixed to the machine body 2. In each drawing, for convenience, the machine body up-down direction (UDD) is illustrated by an arrow UDD, the machine body front-rear direction (FRD) is illustrated by an arrow FRD and the machine body right-left direction (LRD) is illustrated by an arrow LRD.

As illustrated in FIG. 1, the machine body 2 includes a drive section 24, an operator room 22 and one or more (two in the example of FIG. 1) underbodies 21.

The drive section 24 is configured to drive and control the sprocket 212 of each underbody 21 of the machine body 2. In this example, the drive section 24 is configured as a hydraulic type, and includes, for example, an engine, a hydraulic pump and a control valve.

Additionally, the drive section 24 may be configured to drive the sprocket 212 by types other than a hydraulic type.

Also, the drive section 24 may be configured to drive portions other than the sprocket 212 (an attachment etc.) in the machine body 2.

The operator room 22 is configured such that the operator enters an inner portion of the operator room 22 to drive the traveling machine 3.

The rubber crawler 1 is mounted around the underbody 21. The underbody 21 of the machine body 2 and the rubber crawler 1 mounted to the underbody 21 constitute the underbody apparatus 31 of the traveling machine 3. The underbody 21 of the machine body 2 is configured such that the underbody apparatus 31 of the traveling machine 3 travels on the road surface by transmitting the driving force to the rubber crawler 1 mounted around the underbody 21.

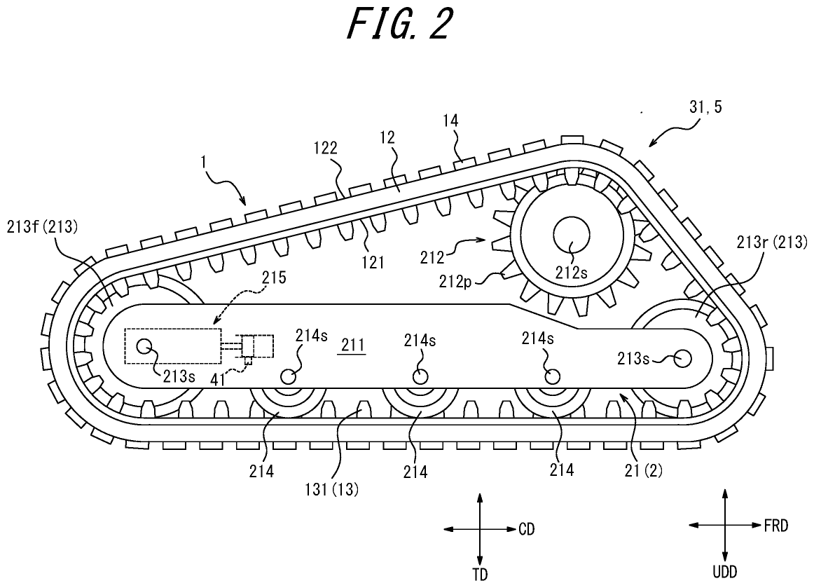

FIG. 2 illustrates the underbody apparatus 31 of the traveling machine 3. As illustrated in FIG. 2, the underbody 21 of the machine body 2 includes a plurality of rotating bodies 212 to 214, a frame 211 and a tension mechanism 215. The underbody 21 includes the sprocket 212, one or more idlers 213 and one or more track rollers 214 as the rotating bodies 212 to 214.

The sprocket 212 is a drive wheel. The sprocket 212 is configured to rotate in accordance with control by the drive section 24 (FIG. 1). The sprocket 212 is attached to a shaft 212s. The sprocket 212 has a plurality of pins 212p at its outer circumferential side. Each pin 212p is configured to enter the hole 16 of the rubber crawler 1 to engage with the central portion 132c of the core 13, thereby transmitting the driving force to the rubber crawler 1.

Additionally, the sprocket 212 is not limited to one illustrated, and may have an arbitrary configuration.

In an example of FIG. 2, the sprocket 212 is arranged at an upper side than the idler 213 and the track roller 214.

The idler 213 is an idling wheel. The idler 213 has a function of maintain tension of the rubber crawler 1. In the example of FIG. 2, one underbody 21 has two idlers 213. These two idlers 213 are arranged to face to each other in the machine body front-rear direction FRD. Of these two idlers 213, a front-side idler 213f is a front idler, and a rear-side idler 213r is a rear idler. Each idler 213 is supported by a support shaft 213s and configured to rotate due to friction with the rubber crawler 1. The support shaft 213s is attached to the frame 211.

As clear from FIG. 2, in this example, the idler 213 generally constitutes a rolling portion configured to pass through between the pair of projections 131 of the core 13 of the rubber crawler 1. Additionally, the idler 213 is not limited to one illustrated, and may have an arbitrary configuration. For example, instead of or in addition to the rolling portion configured to pass through between the pair of projections 131 of the core 13, the idler 213 may have two rolling portions configured to pass through both outer sides in the crawler width direction WD to the pair of projections 131 of the core 13.

The track roller 214 has a function of supporting a load and guiding the rubber crawler 1 to inhibit deviation. In the example of FIG. 2, three track rollers 214 are arranged between the pair of idlers 213. However, the number of track rollers 214 may be arbitrary. Each track roller 214 is supported by a support shaft 214s, and configured to rotate due to friction with the rubber crawler 1. The support shaft 214s is attached to the frame 211.

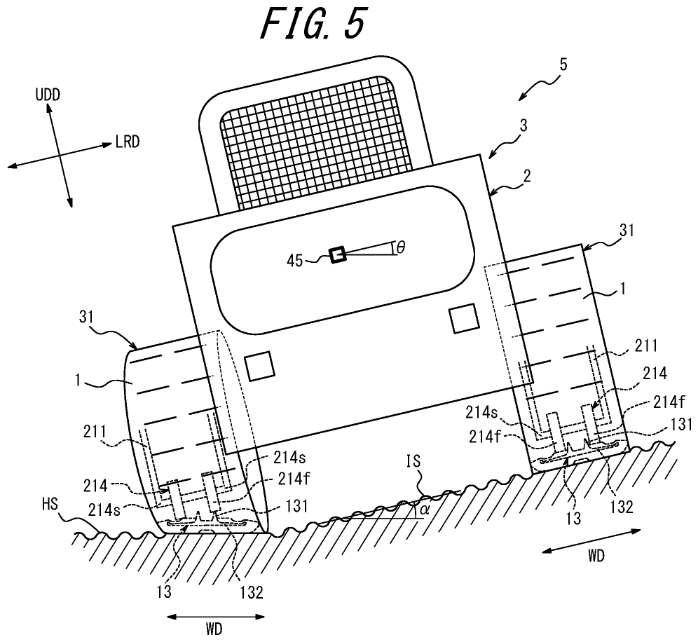

As clear from FIG. 2 and FIG. 5 which will be described later, in this example, each track roller 214 has two rolling portions 214f configured to pass on the track roller passing surfaces 121a (FIG. 3) at both outer sides in the crawler width direction WD to the pair of projections 131 of the core 13. However, each track roller 214 is not limited to one illustrated, and may have an arbitrary configuration. For example, instead of or in addition to the rolling portions 214f configured to pass through both outer sides in the crawler width direction WD to the pair of projections 131 of the core 13, each track roller 214 may include one rolling portion configured to pass through between the pair of projections 131 of the core 13.

The tension mechanism 215 is connected to the idler 213, and more specifically, connected to the support shaft 213s of the idler 213. The tension mechanism 215 is configured to adjust the tension of the rubber crawler 1 by adjusting a force acting between the idler 213 and the rubber crawler 1.

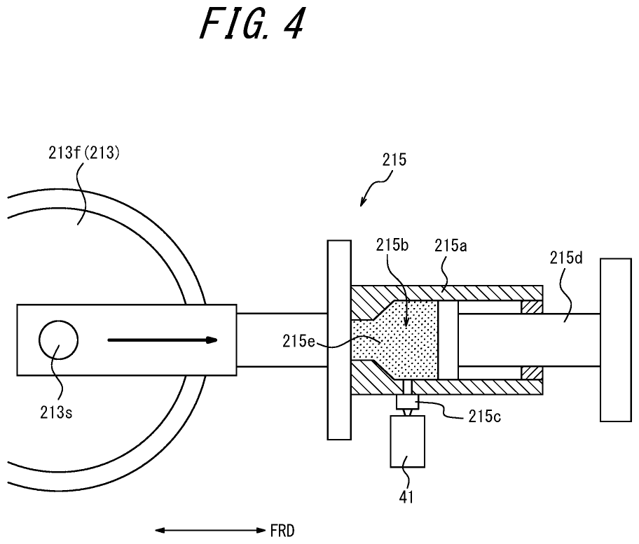

As illustrated in FIGS. 2 and 4, in this example, the tension mechanism 215 is connected to the front idler 213f, and more specifically, connected to the support shaft 213s of the front idler 213f. However, the tension mechanism 215 may be connected to the rear idler 213r, and more specifically, may be connected to the support shaft 213s of the rear idler 213r.

In this example, the tension mechanism 215 has a grease cylinder 215a, a piston rod 215d, a grease nipple 215c and grease 215e. The grease cylinder 215a is connected to the idler 213 (more concretely, the support shaft 213s of the idler 213). The piston rod 215d is configured such that an inner portion of the grease cylinder 215a can be relatively displaced in an axial direction of the piston rod 215d to the grease cylinder 215a. An accommodation space 215b is defined in an inner portion of the grease cylinder 215a, and the grease 215e is housed in the accommodation space 215b. The accommodation space 215b is also defined by one end portion (a left end portion in FIG. 4) in the axial direction of the piston rod 215d, and due to relative displacement in the axial direction of the piston rod 215d, a volume of the accommodation space 215b can be changed. The other end portion (a right end portion in FIG. 4) in the axial direction of the piston rod 215d may be connected to a not illustrated recoil spring for example, or may be fixed to the frame 211 and the like. The grease nipple 215c is configured to adjust the amount of the grease 215e in the accommodation space 215b of the grease cylinder 215a by injecting or ejecting the grease 215e manually etc. via the grease nipple 215c. The tension mechanism 215 with the above configuration is configured such that the force acting between the idler 213 and the rubber crawler 1 can be adjusted, and thus the tension of the rubber crawler 1 can be adjusted by adjusting the amount of the grease 215e in the accommodation space 215b of the grease cylinder 215a via the grease nipple 215c. The larger the amount of the grease 215e in the accommodation space 215b becomes, the larger the force acting between the idler 213 and the rubber crawler 1 (in the example in the drawing, a force in the machine body front-rear direction FRD) becomes, and thus the tension of the rubber crawler 1 increases.

Additionally, the underbody 21 of the machine body 2 is not limited to one illustrated, and may have an arbitrary configuration. For example, the underbody 21 may have only one idler 213. In such a case, the idler 213 is preferably arranged to face the sprocket 212 in the machine body front-rear direction FRD, and the track roller 214 is preferably arranged between the sprocket 212 and the idler 213.

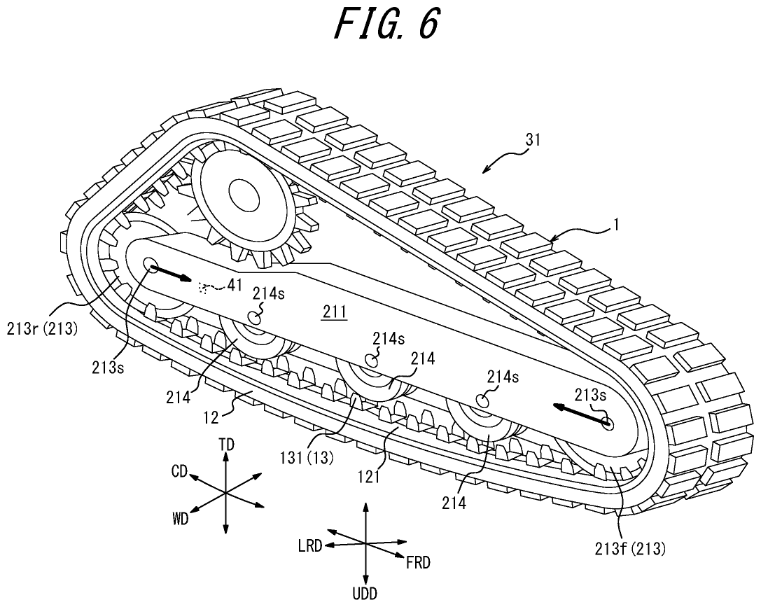

In the traveling machine 3 thus configured, at the time of traveling on an inclined surface, deviation may occur. Here, deviation will be explained with reference to FIGS. 5 and 6.

FIG. 5 is a drawing illustrating an appearance of the traveling machine 3 of FIG. 1 seen from the rear side for explaining a state that there is a prior warning of deviation in the traveling machine 3 of FIG. 1. FIG. 6 illustrates an appearance of the left underbody apparatus 31 in FIG. 5 seen from an inner side in the machine body right-left direction LRD (from the right side of FIG. 5).

Additionally, in the present specification, “deviation” refers to removal of the rubber crawler 1 from the underbody 21 of the machine body 2, and more specifically, refers to a state that the rolling portion 214f of the track roller 214 overrides the projection 131 of the core 13 and is positioned at an opposite side from a position at which it should be normally located about the projection 131. Consequently, while a concrete aspect of deviation is different depending on a structure of the track roller 214, in an example of FIG. 5 for example, deviation of the track roller 214 refers to a state that any one of the pair of rolling portions 214f of the track roller 214 overrides the projection 131 of the core 13 and is positioned between the projections 131 of the core 13.

At the time of traveling on the inclined surface of the traveling machine 3, mainly as illustrated in FIG. 5, deviation tends to occur when the machine body right-left direction LRD of the machine body 2 is inclined to a horizontal surface, and moreover, the machine body right-left direction LRD of the machine body 2 and the crawler width direction WD of the rubber crawler 1 are different from each other (that is, mutually non-parallel), whereby the underbody 21 of the machine body 2 is floated from the rubber crawler 1. Such difference between the machine body right-left direction LRD of the machine body 2 and the crawler width direction WD of the rubber crawler 1 tends to occur when, as in an example in FIG. 5 for example, of the right and left pair of underbody apparatuses 31, the rubber crawler 1 of one underbody apparatus 31 (the right side of FIG. 5) contacts an inclined road surface IS which is inclined in a right-left direction to the horizontal surface, while the rubber crawler 1 of the other underbody apparatus 31 (the left side of FIG. 5) contacts a horizontal road surface HS which is substantially parallel to the horizontal surface. In this case, in the underbody apparatus 31 which contacts the inclined road surface IS (the right side in FIG. 5), the machine body right-left direction LRD of the underbody 21 of the machine body 2 and the crawler width direction WD of the rubber crawler 1 are substantially parallel to the inclined road surface IS and substantially parallel to each other, so that there is no risk of deviation. On the other hand, in the underbody apparatus 31 which contacts the horizontal road surface HS (the left side in FIG. 5), the machine body right-left direction LRD of the underbody 21 of the machine body 2 is substantially parallel to the inclined road surface IS, while, as also illustrated in FIG. 6, the rubber crawler 1 is twisted to droop down mainly at a portion between the pair of idlers 213 in the machine body front-rear direction FRD to contact the horizontal road surface HS to be substantially parallel thereto, whereby the crawler width direction WD of the rubber crawler 1 is substantially parallel to the horizontal road surface HS (and thus the horizontal surface), and as a result, the track roller 214 of the underbody 21 of the machine body 2 is floated from the rubber crawler 1. This may lead a state of existence of a prior warning of deviation, for example, the rolling portion 214f of the track roller 214 of the underbody 21 overrides the projection 131 of the core 13 of the rubber crawler 1. Moreover, when an inclination angle θ of the machine body right-left direction LRD of the machine body 2 to the horizontal surface becomes larger, the rolling portion 214f of the track roller 214 is moved to the opposite side about the projection 131, which may lead deviation.

Additionally, at the time of traveling on the inclined surface as described above, the deviation occurs more easily as the inclination angle θ of the machine body right-left direction LRD of the machine body 2 to the horizontal surface becomes larger.

(Monitoring System 4)

Next, the monitoring system 4 of this embodiment will be explained. As describe above, the monitoring system 4 is configured to monitor as to whether the prior warning of deviation exists in the traveling machine 3. A user of the monitoring system 4 is, for example, the operator who drives the traveling machine 3.

As illustrated in FIG. 1. the monitoring system 4 includes an angle sensor 45, a force sensor 41, a processing section 42, a notification section 43 and a storing section 44.

The angle sensor 45 is configured to detect the inclination angle θ (FIG. 5) of the machine body 2 to the horizontal surface. The inclination angle θ of the machine body 2 to the horizontal surface concretely refers to the inclination angle in the machine body right-left direction LRD of the machine body 2 to the horizontal surface. A detected signal of the inclination angle θ detected by the angle sensor 45 is outputted to the processing section 42.

The angle sensor 45 is, for example, constituted by a level.

The angle sensor 45 is attached to the machine body 2. The angle sensor 45 may be attached to an arbitrary portion in the machine body 2.

Preferably, the angle sensor 45 outputs the detected signal of the inclination angle θ to the processing section 42, for example continuously or every predetermined time interval, during traveling of the traveling machine 3.

As in the example in FIG. 5 for example, in a case where, of the right and left pair of underbody apparatuses 31, the rubber crawler 1 of one underbody apparatus 31 (the right side in FIG. 5) contacts the inclined road surface IS which is inclined in the right-left direction to the horizontal surface, while the rubber crawler 1 of the other underbody apparatus 31 (the left side of FIG. 5) contacts the horizontal road surface HS which is substantially parallel to the horizontal surface, the inclination angle θ detected by the angle sensor 45 substantially corresponds to an inclination angle α (FIG. 5) of the inclined road surface IS to the horizontal surface, and substantially corresponds to an angle made by the machine body right-left direction LRD of the underbody 21 in the underbody apparatus 31 which contacts the horizontal road surface HS (the left side of FIG. 5) and the crawler width direction WD of a portion of the rubber crawler 1 which contacts the horizontal road surface HS to be substantially parallel thereto.

The force sensor 41 is configured to detect a force applied from the rubber crawler 1 to the idler 213 of the underbody 21 (the front idler 213f or the rear idler 213r) or a physical amount correlating with the force.

A detected signal of the force detected by the force sensor 41 or the physical amount correlating with the force is outputted to the processing section 42.

The force sensor 41 preferably outputs the detected signal of the force or the physical amount to the processing section 42, for example, continuously or every predetermined time interval, during traveling of the traveling machine 3.

The force sensor 41 is preferably attached to the underbody apparatus 31, and more preferably, is attached to the underbody 21.

Here, as the “physical amount correlating with the force,” any force can be applied as long as it is a physical amount which is changed substantially in proportion to the force.

In this example, the force sensor 41 is configured as a pressure sensor. As illustrated in FIG. 4, the force sensor 41 is configured to detect pressure in the accommodation space 215b of the grease cylinder 215a of the tension mechanism 215 connected to the idler 213 (more specifically, the front idler 213f in this example), thereby detecting a physical amount (a pressure in this example) correlating with a force applied from the rubber crawler 1 to the idler 213 (more specifically, the front idler 213f in this example) of the underbody 21. The larger the force applied from the rubber crawler 1 to the idler 213 (more specifically, the front idler 213f in this example) of the underbody 21 becomes, the larger the pressure in the accommodation space 215b of the grease cylinder 215a becomes.

In the example of FIG. 4, the force sensor 41 is configured to detect the pressure in the accommodation space 215b of the grease cylinder 215a via the grease nipple 215c. However, the force sensor 41 may be configured to detect the pressure in the accommodation space 215b of the grease cylinder 215a based on the configuration which is different from that in the example in FIG. 4.

In the example in FIG. 4, the tension mechanism 215 is connected to the front idler 213f, and accordingly, the force sensor 41 is configured to detect a physical amount correlating with a force applied from the rubber crawler 1 to the front idler 213f. However, in a case where the tension mechanism 215 is connected to the rear idler 213r for example, the force sensor 41 may be configured to detect a physical amount correlating with a force applied from the rubber crawler 1 to the rear idler 213r.

Additionally, the force applied from the rubber crawler 1 to the front idler 213f is always substantially the same as the force applied from the rubber crawler 1 to the rear idler 213r.

Also, the force sensor 41 may be configured to detect the force applied from the rubber crawler 1 to the idler 213 of the underbody 21 or the physical amount correlating with the force by methods other than a method of detecting the pressure in the accommodation space 215b of the grease cylinder 215a.

For example, the force sensor 41 may be configured as a strain sensor, and configured to detect the force applied from the rubber crawler 1 to the idler 213 of the underbody 21 or the physical amount (for example, a strain or a voltage) correlating with the force. In such a case, for example, the force sensor 41 is preferably attached to the support shaft 213s of the idler 213 (the front idler 213f or the rear idler 213r) of the underbody 21 or a portion which is adjacent to the support shaft 213s of the frame 211.

Also, in the example in FIG. 4, the force sensor 41 is configured to detect the force applied from the rubber crawler 1 to the idler 213 in the machine body front-rear direction FRD or the physical amount correlating with the force. However, the force sensor 41 may be configured to detect a force applied from the rubber crawler 1 to the idler 213 in an arbitrary direction or a physical amount correlating with the force.

Additionally, in a case where the machine body right-left direction LRD of the machine body 2 and the crawler width direction WD of the rubber crawler 1 are mutually different from each other (that is, mutually non-parallel) as in the left underbody apparatus 31 in the example of FIG. 5, the larger the inclination angle θ of the machine body 2 to the horizontal surface in the machine body right-left direction LRD becomes, the more the rubber crawler 1 is twisted severely, which increases the tension of the rubber crawler 1, and thus the force applied from the rubber crawler 1 to the idler 213 increases.

The processing section 42 is configured to control the entire monitoring system 4 which includes the angle sensor 45, the force sensor 41, the storing section 44 and the notification section 43 by executing a program stored in the storing section 44.

For example, the processing section 42 is configured to determine existence or non-existence of the prior warning of deviation based on outputs from the angle sensor 45 and the force sensor 41. More specifically, in this example, the processing section 42 is configured to determine that there is the prior warning of deviation when the inclination angle θ detected by the angle sensor 45 is larger than a predetermined angle and the force or the physical amount outputted from the force sensor 41 is larger than a predetermined force or physical amount. Also, the processing section 42 is configured to cause the notification section 43 to notify a warning when it is determined that there is the prior warning of deviation. Moreover, the processing section 42 is configured to, instead of or in addition to notifying by the notification section 43, cause the drive section 24 of the machine body 2 to reduce the driving force when it is determined that there is the prior warning of deviation. A concrete processing of the processing section 42 will be explained later.

The processing section 42 is configured to include at least one processor such as a CPU (Central Processing Unit). The processing section 42 may be achieved by one processor, or may be achieved by a plurality of processors. The processor may be achieved as a single integrated circuit. The integrated circuit is also referred to as IC (Integrated Circuit). The processor may be achieved as a plurality of integrated circuits connected to be capable of communication and a discrete circuit. The processor may be achieved based on other various known technologies.

The processing section 42 may store an output from the angle sensor 45 or the force sensor 41 and/or a result of processing by the processing section 42 in the storing section 44.

The processing section 42 may be provided to the machine body 2, or may be provided at a place which is remote from the machine body 2. In a case where the processing section 42 is provided to the machine body 2, communication among the processing section 42, the angle sensor 45, the force sensor 41, the notification section 43 and the drive section 24 may be wire communication or wireless communication. In a case where the processing section 42 is provided at the place which is remote from the machine body 2, communication among the processing section 42, the angle sensor 45, the force sensor 41, the notification section 43 and the drive section 24 preferably may be at least partially wireless communication.

The storing section 44 stores the program to be executed by the processing section 42 or various information which is used for processing executed by the processing section 42 and the like.

The storing section 44 is constituted by one or more ROM or one or more RAM, for example. While the storing section 44 may be configured by a semiconductor memory or a magnetic disk, for example, not limited to this, may be configured as an arbitrary storage unit. Also, for example, the storing section 44 may be configured from an external storage unit such as a memory card (including a USB). Also, the storing section 44 may be an internal memory of the processor constituting the processing section 42.

The storing section 44 may be provided to the machine body 2, or may be provided at the place which is remote from the machine body 2.

The notification section 43 is provided to the machine body 2. The notification section 43 is configured to notify a warning to the operator who drives in the operator room 22 in accordance with control by the processing section 42. The notification section 43 can have, for example, at least one of a display or a voice output section. For example, the display capable of constituting the notification section 43 can include a display or a monitor configured to display a letter, an image, a movie and the like and/or a lamp configured to emit a light. For example, the voice output section capable of constituting an output section 85 can include a speaker configured to output a voice.

[Motoring Method]

Next, a method of monitoring the traveling machine 3 (and thus the monitoring method according to one embodiment of the present disclosure) using the monitoring system 4 of the above-described embodiment (and thus the traveling machine system 5 of this embodiment) will be explained. The monitoring method of this embodiment is used to monitor as to whether there is the prior warning of deviation in the traveling machine 3.

Additionally, the monitoring method which will be explained below is not limited to the monitoring system 4 of the above-described embodiment, and can be achieved in the same manner using the monitoring system 4 related to another example explained in the present specification.

The monitoring method of this embodiment includes an angle detecting step, a force detecting step, a determining step and a countermeasure step.

(Angle Detecting Step)

In the angle detecting step, the angle sensor 45 detects the inclination angle θ of the machine body 2 to the horizontal surface (that is, the inclination angle of the machine body 2 to the horizontal surface in the machine body right-left direction LRD). The angle detecting step is executed during traveling of the traveling machine 3. The angle sensor 45 outputs a detected signal of the inclination angle θ to the processing section 42. The output from the angle sensor 45 to the processing section 42 is preferably executed in real time.

The angle sensor 45 preferably outputs the detected signal of the inclination angle θ to the processing section 42, for example continuously or every predetermined time interval, during traveling of the traveling machine 3.

(Force Detecting Step)

In the force detecting step, the force sensor 41 detects the force applied from the rubber crawler 1 to the idler 213 of the underbody 21 or the physical amount correlating with the force. The force detecting step is executed during traveling of the traveling machine 3. The force sensor 41 outputs a detected signal of the force or the physical amount to the processing section 42. The output from the force sensor 41 to the processing section 42 is preferably executed in real time.

The force sensor 41 preferably outputs the detected signal of the force or the physical amount to the processing section 42, for example continuously or every predetermined time interval, during traveling of the traveling machine 3.

More specifically, in this example, in the force detecting step, the force sensor 41 detects the pressure in the accommodation space 215b of the grease cylinder 215a of the tension mechanism 215 connected to the idler 213 (more specifically, the front idler 213f in this example) as the physical amount correlating with the force applied from the rubber crawler 1 to the idler 213, and outputs the detected signal of the detected pressure.

(Determining Step)

In the determining step, the processing section 42 determines existence or non-existence of the prior warning of deviation based on the output from the angle sensor 45 in the angle detecting step and the output from the force sensor 41 in the force detecting step.

The processing section 42 preferably executes the determining step, for example continuously or every predetermined time interval, during traveling of the traveling machine 3.

More specifically, in this example, in the determining step, the processing section 42 compares the inclination angle θ detected by the angle sensor 45 in the angle detecting step (and thus the detected signal outputted from the angle sensor 45. Hereinafter, it is referred to as “a detected angle DA”) with a predetermined angle (hereinafter, it is referred to as “a threshold angle TA”), and compares the force or the physical amount detected by the force sensor 41 in the force detecting step (and thus the detected signal outputted from the force sensor 41. Hereinafter, it is referred to as “a detected force etc. DF”) with a predetermined force or physical amount (hereinafter, it is referred to as “a threshold force etc. TF”). Moreover, in the determining step, the processing section 42 determines that there is the prior warning of deviation when the detected angle DA is larger than the threshold value TA and the detected force etc. DF is larger than the threshold force etc. TF, while it determines that there is no prior warning of deviation in the other cases.

(Countermeasure Step)

In the countermeasure step, a countermeasure is taken to prevent deviation when the processing section 42 determines that there is the prior warning of deviation in the determining step.

As an example of a concrete countermeasure, the processing section 42 may cause the notification section 43 provided to the machine body 2 to notify a warning to the operator. In this case, the operator who received the warning from the notification section 43 can prevent deviation by stopping the traveling machine 3 or operating in a reverse direction.

As another example of the concrete countermeasure, the processing section 42 may control the drive section 24 of the machine body 2. Due to this, deviation can be automatically prevented without the need of operation by the operator. In this case, for example, the processing section 42 may stop the machine body 2 or reduce its speed by causing the drive section 24 to reduce the driving force. Alternatively, the processing section 42 may control the drive section 24 of the machine body 2 to change a traveling direction of the machine body 2 (for example, executing travelling in a reverse direction).

The countermeasure step can inhibit occurrence of the deviation.

Additionally, in the countermeasure step, the processing section 42 may execute any one of the notification by the notification section 43 and the control of the drive section 24 or may execute both at the same time.

Here, a function effect of the monitoring system 4 of the above-described embodiment, the traveling machine system 5 of this embodiment and the monitoring method of this embodiment will be explained.

In this embodiment, as described above, the angle sensor 45 detects the inclination angle θ of the machine body 2 to the horizontal surface, and the force sensor 41 detects the force applied from the rubber crawler 1 to the idler 213 of the underbody 21 or the physical amount correlating with the force, and moreover, the processing section 42 determines existence or non-existence of the prior warning of deviation based on the outputs from the angle sensor 45 and the force sensor 41. More specifically, in this example, as described above, the processing section 42 is configured to determine that there is the prior warning of deviation when the inclination angle outputted from the angle sensor 45 (the detected angle DA) is larger than a predetermined angle (the threshold value TA) and the force or the physical amount outputted from the force sensor 41 (the detected force etc. DF) is larger than a predetermined force or physical amount (the threshold force etc. TF).

Conventionally, the operator who drives the traveling machine has required to predict the prior warning of deviation sensuously from the attitude of the machine body, the traveling state or the sound etc., and grasping the prior warning of deviation has been difficult, and thus preventing the deviation has been difficult. Occurrence of deviation may lead downtime accompanied by recovery efforts or damage to the rubber crawler (for example, breakage of the rubber crawler due to an excessive tension, and cutting or removal of rubber of the rubber crawler caused by interference with the frame of the machine body).

Regarding this point, in this embodiment, the processing section 42 determines existence or non-existence of the prior warning of deviation based on the outputs from the angle sensor 45 and the force sensor 41, which ensures grasping of the prior warning of deviation more reliably, and thus deviation is inhibited from occurring. By inhibiting the deviation from occurring, downtime can be reduced, and inhibiting construction period delay and inhibiting occurrence of the cost of recovery of the machine body etc. can be achieved. Also, by inhibiting the deviation from occurring, damage of the rubber crawler 1 is inhibited, and a service life of the rubber crawler 1 can be made longer.

Also, in this embodiment, the processing section 42 determines existence or non-existence of the prior warning of deviation based on the outputs from both the angle sensor 45 and the force sensor 41, so that the prior warning of deviation can be grasped more correctly. In other words, unlike the example in FIG. 5, in a case where both the rubber crawlers 1 of the right and left pair of underbody apparatuses 31 of the traveling machine 3 contact the inclined road surface IS which is inclined in the right-left direction to the horizontal surface, in both the underbody apparatuses 31, the machine body right-left direction LRD of the machine body 2 and the crawler width direction WD of the rubber crawler 1 are substantially parallel, so that deviation is difficult to occur. Accordingly, if the processing section 42 determines existence or non-existence of the prior warning of deviation only based on the output from the angle sensor 45, a case where the rubber crawler 1 of one underbody apparatus 31 contacts the inclined surface IS, while the rubber crawler 1 of the other underbody apparatus 31 contacts to the horizontal road surface HS as in the example of FIG. 5 (and thus deviation easily occurs) cannot be differentiated from a case where the rubber crawlers 1 of both the underbody apparatuses 31 contact the inclined road surface IS as described above (and thus deviation is difficult to occur). In a case where the machine body right-left direction LRD of the machine body 2 and the crawler width direction WD of the rubber crawler 1 are different from each other (that is, mutually non-parallel) as in the left underbody apparatus 31 of the example of FIG. 5, the larger the inclination angle θ of the machine body 2 to the horizontal surface in the machine body right-left direction LRD becomes, the more the rubber crawler 1 is twisted severely, which increases the tension of the rubber crawler 1, and thus the force applied from the rubber crawler 1 to the idler 213 increases. In this embodiment, focusing this mechanism, the processing section 42 observes the output from the force sensor 41 in addition to the output from the angle sensor 45, so that existence of the prior warning of deviation can be appropriately determined only when the rubber crawler 1 is twisted, and thus the prior warning of deviation can be grasped more correctly.

Also, in this example, as described above, when the processing section 42 determines that there is the prior warning of deviation, a countermeasure of causing the notification section 43 provided to the machine body 2 to notify a warning and/or controlling the drive section 24 of the machine body 2 (reducing the driving force of the drive section 24 etc.) is taken. Due to this, the deviation can be inhibited from occurring more reliably. Moreover, the operator can concentrate on driving since prediction of the prior warning of deviation is not required during traveling of the traveling machine 3.

Additionally, preferably, the threshold angle TA, the threshold force etc. TF used in the determining step are set by a previous traveling test.

In each example explained in the present specification, the monitoring system 4 may set the threshold angle TA and/or the threshold force etc. TF used in the determining step at a plurality of stages depending on severity of the prior warning of deviation. Moreover, in the determining step, the processing section 42 may determine the severity of the prior warning of deviation in addition to existence or non-existence of the prior warning of deviation by comparing the output from the angle sensor 45 in the angle detecting step (the detected angle DA) and/or the output from the force sensor 41 in the force detecting step (the detected force etc. DF) with the plurality of threshold values (the threshold angle TA and/or the threshold force etc. TF). In addition, the processing section 42 may change the content of the countermeasure in the countermeasure step depending on the severity of the prior warning of deviation determined in the determining step. For example, the processing section 42 may cause the notification section 43 to execute notification in the countermeasure step when it is determined that the severity of the prior warning of deviation is low in the determining step, while may control the drive section 24 of the machine body 2 to stop the machine body 2 in the countermeasure step when it is determined that the severity of the prior warning of deviation is high in the determining step.

In each example explained in the present specification, the monitoring system 4 preferably includes the force sensor 41 in each underbody 21. In this case, the processing section 42 determines existence or non-existence of the prior warning of deviation for each output from each force sensor 41 (that is, every underbody 21) in the determining step. Moreover, the processing section 42 preferably executes the countermeasure step when it is determined that there is the prior warning of deviation based on the output from at least any one force sensor 41.

### INDUSTRIAL APPLICABILITY

The monitoring system, the traveling machine system and the monitoring method according to the present disclosure is preferably applied to the traveling machine including the rubber crawler containing the core, and, for example, preferably applied to the construction machinery (including the mini-excavator) and the agricultural machines (including the tractor and the combine).

1. A monitoring system which is used for a traveling machine having a rubber crawler and a machine body, the monitoring system comprising:
an angle sensor;
a force sensor; and
a processing section,
wherein the rubber crawler includes a plurality of cores which are arranged along a crawler circumferential direction and is mounted to an underbody of the machine body,
the angle sensor is configured to detect an inclination angle to a horizontal surface of the machine body,
the force sensor is configured to detect a force applied from the rubber crawler to an idler of the underbody or a physical amount correlating with the force, and
the processing section is configured to determine existence or non-existence of a prior warning of deviation based on outputs from the angle sensor and the force sensor.

2. The monitoring system according to claim 1, wherein the idler is a front idler.

3. The monitoring system according to claim 1, wherein the processing section is configured to determine that there is a prior warning of deviation when the inclination angle detected by the angle sensor is larger than a predetermined angle and the force or the physical amount detected by the force sensor is larger than a predetermined force or physical amount.

4. The monitoring system according to claim 1, wherein the processing section is configured to cause a notification section provided to the machine body to notify a warning and/or cause a drive section of the machine body to reduce a driving force when it is determined that there is a prior warning of deviation.

5. The monitoring system according to claim 1, wherein the force sensor is configured to detect pressure in a grease cylinder of a tension mechanism connected to the idler.

6. The monitoring system according to claim 1, wherein the force sensor is attached to a support shaft of the idler in the underbody.

7. The monitoring system according to claim 2, wherein the processing section is configured to determine that there is a prior warning of deviation when the inclination angle detected by the angle sensor is larger than a predetermined angle and the force or the physical amount detected by the force sensor is larger than a predetermined force or physical amount.

8. The monitoring system according to claim 2, wherein the processing section is configured to cause a notification section provided to the machine body to notify a warning and/or cause a drive section of the machine body to reduce a driving force when it is determined that there is a prior warning of deviation.

9. The monitoring system according to claim 3, wherein the processing section is configured to cause a notification section provided to the machine body to notify a warning and/or cause a drive section of the machine body to reduce a driving force when it is determined that there is a prior warning of deviation.

10. The monitoring system according to claim 2, wherein the force sensor is configured to detect pressure in a grease cylinder of a tension mechanism connected to the idler.

11. The monitoring system according to claim 3, wherein the force sensor is configured to detect pressure in a grease cylinder of a tension mechanism connected to the idler.

12. The monitoring system according to claim 4, wherein the force sensor is configured to detect pressure in a grease cylinder of a tension mechanism connected to the idler.

13. The monitoring system according to claim 2, wherein the force sensor is attached to a support shaft of the idler in the underbody.

14. The monitoring system according to claim 3, wherein the force sensor is attached to a support shaft of the idler in the underbody.

15. The monitoring system according to claim 4, wherein the force sensor is attached to a support shaft of the idler in the underbody.

16. The monitoring system according to claim 5, wherein the force sensor is attached to a support shaft of the idler in the underbody.

17. A traveling machine system comprising:
the monitoring system according to claim 1; and
the traveling machine including the rubber crawler and the machine body.

18. A traveling machine system comprising:
the monitoring system according to claim 2; and
the traveling machine including the rubber crawler and the machine body.

19. A traveling machine system comprising:
the monitoring system according to claim 3; and
the traveling machine including the rubber crawler and the machine body.

20. A monitoring method which uses the monitoring system according to claim 1, comprising:
an angle detecting step in which the angle sensor detects an inclination angle to a horizontal surface of the machine body;
a force detecting step in which the force sensor detects the force applied from the rubber crawler to the idler of the underbody or the physical amount correlating with the force; and
a determining step in which the processing section determines existence or non-existence of the prior warning of deviation based on the output from the angle sensor in the angle detecting step and the output from the force sensor in the force detecting step.
